(19) United States
(12) Patent Application Publication
(10) Pub. No.: US 2007/0019787 A1
(43) Pub. Date: Jan. 25, 2007

(54) Fusion imaging using gamma or x-ray cameras and a photographic-camera

(76) Inventor: Lionel S. Zuckier, Teaneck, NJ (US)

Correspondence Address: GOTTLIEB RACKMAN & REISMAN PC, 270 MADISON AVENUE, 8TH FLOOR, NEW YORK, NY, 100160601, US

(21) Appl. No.: 11/030,564

(22) Filed: Jan. 6, 2005

Related U.S. Application Data
(60) Provisional application No. 60/584,510, filed on Jul. 1, 2004.
(60) Provisional application No. 60/534,510, filed on Jan. 6, 2004.

(51) Int. Cl. G01N 23/04

(52) U.S. Cl. 378/63

(57) ABSTRACT

A visual photographic camera is utilized in a fixed geometric relationship together with another imaging or treatment source such as a standard gamma-camera or an x-ray source. The visual camera is either attached to the gamma camera gantry, the gamma camera head or mounted on a structure such as the ceiling in the imaging room. After the standard gamma camera image is obtained, the gamma-camera head can rotate either bringing the visual camera over the patient, or moving out of the way to expose the patient to the field of view of the gantry-mounted or ceiling mounted camera. On the fusion image, both the visual and scintigraphic parameters for each specific location on the patient's body may be coded in a display. The visual camera may be utilized together with x-ray imaging equipment. In that application, the visual camera could either be attached to the x-ray tube assembly, or be mounted on a structure in the imaging room. Based on a fixed relationship between the location of the x-ray machine and the photographic camera, the two images could be scaled and superimposed to generate a ‘fusion’ image.

This application claims the benefit of U.S. provisional application 60/584,510 filed Jan. 6, 2004.

### FIELD OF THE INVENTION

This application relates to the art of diagnostic imaging. In particular it relates to simultaneous gamma-camera and photographic-camera imaging of a patient.

### BACKGROUND OF THE INVENTION

Medical image analysis often involves the fusion, or image registration of images produced by different imaging sources. Registration is the process of aligning data into one consistent coordinate frame, particularly where tissues appear with different resolution in different types of imaging methods. Another situation is where a therapeutic source of radiation is used which does not present clear anatomic references and use of the source is supplemented by an alternative more clearly visible source in order to determine the placement of the therapeutic source. When acquired, multiple scans of the same patient will generally be unregistered, as the patient may be in different positions in each scanner, and each scanner has its own coordinate system. In order to fuse the information from all scans into one coherent frame, the scans must be registered.

The feature that makes multiple scans useful, namely that they see the same source differently, complicates the registration process. As each modality images tissue differently and has its own artifacts, accurately modeling the intensity relationship between the scans, and subsequently aligning them, is difficult.

This has generally been handled as a mathematical problem in the combination of reference images. The registration of two images has been treated as the problem of finding the mathematical transformation that best maps one image onto the other. Where the problem has been the patient being in different positions in the scanning devices used to image the anatomy the type of mathematical transformations has been mainly a rigid rotation of one image into another.

One method of aligning the two images is to use a patient-centered coordinate system employing the use of fiducial markers attached to a patient throughout the various image acquisitions. These fiducial markers define a patient oriented coordinate system independent of the scanner or choice of imaging modality.

When fiducial markers are not used to define the patient coordinate frame, anatomical features present in the images are used to align the images. But this approach depends greatly on the ability to determine reliable image features. In general, methods of feature extraction such as intensity thresholding or edge detection do not work well on medical scans.

U.S. Pat. No. 6,662,036 to Sherwood Services AG for “Surgical Positioning System” describes a system for positioning a patient with respect to a treatment or imaging machine, which includes multiple cameras to view the body and the machine. Index markers are located by cameras in 3D space in relation to analogous markers used during previous image scanning of the patient. Movements of the patient are controlled based on comparative analysis of imaging determined anatomical targets relative to reference points on treatment or diagnostic apparatus. Scan data taken from the patient by a CT or MRI scanner is stored in an imager. The scan data is rendered compatible with camera data by translation to a common coordinate space.

U.S. Pat. No. 5,389,101 to University of Utah for “Apparatus and Method for Photogrammetric Surgical Localization” describes locating a medical instrument relative to a patient by using two video cameras to form pairs of two dimensional images along different sightlines. The images from the cameras may be displayed on a viewing screen as well as scan images made by X-rays and angiograms. The various images can be overlaid on a selected view.

Patent Application US 2003/0233039 to Shao et al. for “Physiological Model Based Non-Rigid Image Registration” fuses images from various sources using so-called non-rigid technique to compensate for physiological movement during imaging.

U.S. Pat. No. 5,672,877 to ADAC Laboratories for “Coregistration of Multi-Modality Data in a Medical Imaging System” describes a nuclear medicine imaging system in which an emission scan (viz. a single-photon emission computed tomography SPECT scan) is performed simultaneously with a transmission scan using the same nuclear medicine imaging system. The emission scan is performed using a roving zoom window, while the transmission scan is performed using the full field of view of the defectors. By knowing the position of the zoom windows for each detection angle, the nuclear medicine transmission image data is coregistered with the SPECT emission image data as a result of the simultaneous scans. The emission image is acquired at the same time as the transmission image.

U.S. Pat. No. 5,871,013 to Elscint Ltd. for “Registration of Nuclear Medicine Images” describes a method for registering simultaneous transmission and emission tomography STET images to structural diagnostic images such as MRI, ultrasound or X-ray CT images. The registration is accomplished through choosing and comparing prominent body structures, such as the skeleton, organs or body outlines in each image and transforming one image so that it can be superimposed over an other image.

U.S. Pat. No. 6,501,981 to Accuray, Inc. for “Apparatus and Method for Compensating for Respiratory and Patient Motions During Treatment” is concerned with treating a tumor by radiation therapy where the tumor may be in motion during treatment. The patent describes combining internal markers placed on the target organs with external sensors to accurately track the position and motion of a moving target region, such as an internal organ.

U.S. Pat. No. 6,587,710 to Elgems Ltd. for “Hand-Held Gamma Camera” discloses a hand-held gamma camera used in an operating room where a patient is lying on an operation table where a stationary imaging system, such as an x-ray machine, CAT scanner or other imaging system is used to reference the coordinate of the patent with some known spatial coordinate system. Images from the hand-held gamma camera are superimposed on the patient's coordinate system, which is displayed on an imaging system. The idea is to image objects that are difficult to image by the stationary imaging system by getting very close to them with a small hand-held gamma camera without losing the spatial positioning information that the stationary imaging system yields.

Patent Application US 2002/0147393 to Eurorad for “Pre-Operative Device for Localizing Marked Tissues and Process Using Such a Device” describes the use of different sensors for radioactive radiation and optical radiation in an eleongated probe. The optical and nuclear measurements are made simultaneously and correlated.

### BRIEF DESCRIPTION OF THE INVENTION

The invention concerns having a fixed geometric relationship (e.g. a fixed position and orientation) between a visual photographic camera and another imaging or treatment source (herein also called a “camera”) such as a standard gamma-camera or an x-ray source. The fixed geometric relationship facilitates combining the visual, scintigraphic and/or x-ray data using affine transformations of the images from the varied sources.

The visual camera is either attached to the gamma camera gantry, the gamma camera head or mounted on a structure such as the ceiling in the imaging room. After the standard gamma camera image is obtained, the gamma-camera head can rotate either bringing the visual camera over the patient, or moving out of the way to expose the patient to the field of view of the gantry-mounted or ceiling mounted camera.

Algorithms are used to create and display a ‘fusion’image by scaling and superimposing the images from the two cameras. These algorithms essentially perform an affine transformation of the images to effect registration.

On the fusion image, both the visual and scintigraphic parameters for each specific location on the patient's body may be coded in a display. Intensity of the visual and scintigraphic images could be independently varied to shift the display between the two parameters.

Imaging of a ‘phantom’ physically combines several areas of visual and scintigraphic signal and takes advantage of the fixed geometric relationship between the cameras. This will allow the visual and scintigraphic images to be mapped to accurately superimpose the images.

In one embodiment the visual cameras are superimposed with x-ray imaging equipment. In this application, the visual camera could either be attached to the x-ray tube assembly, or be mounted on a structure in the imaging room. Based on a fixed relationship between the location of the x-ray machine and the photographic camera, the two images could be scaled and superimposed to generate a ‘fusion’ image.

### BRIEF DESCRIPTION OF THE DRAWINGS

FIG. 1 depicts three possible positions for the visual camera when used together with a gamma camera.

FIG. 2 depicts a position in which the gamma camera is located above the patient and acquires the scintigraphic image.

FIG. 3 depicts a device that generates both a visual and scintigraphic phantom signal at several defined locations.

FIG. 4 depicts combining x-ray images with visual images in the present invention.

### DETAILED DESCRIPTION OF THE INVENTION

The invention comprises combining a visual photographic camera with another imaging or treatment source such as a standard gamma-camera (e.g. a scintigraphic camera or Anger camera) or an x-ray source in a fixed geometric relationship that facilitates combining the visual, scintigraphic and/or x-ray data using affine transformations of the images from the varied sources. The fixed geometric relationship allows the combination of clear visible images with those nuclear medicine images that display few anatomic references.

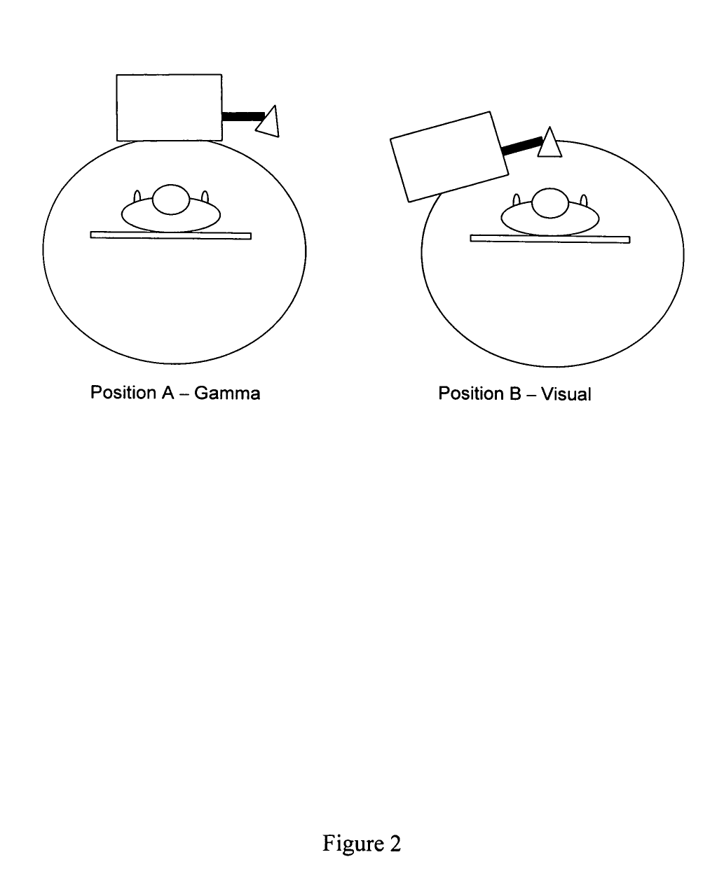

The visual camera is preferably a digital camera that can be remotely operated from the user's console. This camera can either be attached to the gamma camera gantry (position a), the gamma camera head (position y) or mounted on a structure such as the ceiling in the imaging room (positionβ). After the standard gamma camera image is obtained, the gamma-camera head can rotate either bringing the visual camera over the patient (FIG. 2), or moving out of the way to expose the patient to the field of view of the gantry-mounted or ceiling mounted camera.

The gamma-camera may be an Anger camera, which is an imaging device used in nuclear imaging that consists of a lead collimator, placed between a detector surface and the patient. The collimator serves to suppress gamma rays which deviate substantially from the vertical and thus acts as a type of “lens”. The detector may be a single crystal layer of Nal (sodium iodide), which produces light flashes of multiple photons when an impinging gamma ray interacts with the crystal (scintillation camera). The bursts of light flashes are detected by an array of photomultiplier tubes which are optically coupled to the surface of the crystal. The output signal from the photomultipliers is comprised of currents that are proportional to the energy of the gamma ray. Depending on the position of the event, the phototubes are variably activated. Hence, the entire system response yields positional information which is relatively accurate. With actual systems the intrinsic resolution (full width half maximum FWHM) of two radiation sources placed immediately on the crystal surface without the collimator is in the order of 1 mm.

The positional information of the Anger camera is recorded using an analogue output onto film or a digital image may be stored as a digital image in a computer coupled to the camera. The digital image from the Anger camera may be fused with the image from the visual camera.

Algorithms are used to create and display a ‘fusion’ image by scaling and superimposing the images from the two cameras. These algorithms essentially perform an affine transformation of the images to effect registration. An affine transformation is a linear transformation that preserves collinearity (i.e., all points lying on a line initially still lie on a line after transformation) and ratios of distances (e.g., the midpoint of a line segment remains the midpoint after transformation). An affine transformation is a projective transformations that does not move any objects from the affine space to the plane at infinity or conversely. Geometric contraction, expansion, dilation, reflection, rotation, shear, similarity transformations, spiral similarities, and translation are all affine transformations, as are their combinations. In general, an affine transformation is a composition of rotations, translations, dilations, and shears. While an affine transformation preserves proportions on lines, it does not necessarily preserve angles or lengths.

Thus an affine transformation allows fusion or registration of the images from the two sources by correcting for differences in orientation or perspective. Since the location of the cameras is fixed in the present invention, the algorithm may has greater independence of the patient anatomy and is therefore more efficient in effectuating image fusion.

On the fusion image, both the visual and scintigraphic parameters for each specific location on the patient's body may be coded in the display. Because the nuclear medicine image often has very few anatomic references, fusion with a visual image will aid in identifying the location of the areas of nuclear radiation or x-ray uptake. Intensity of the visual and scintigraphic images could be independently varied to shift the display between the two parameters.

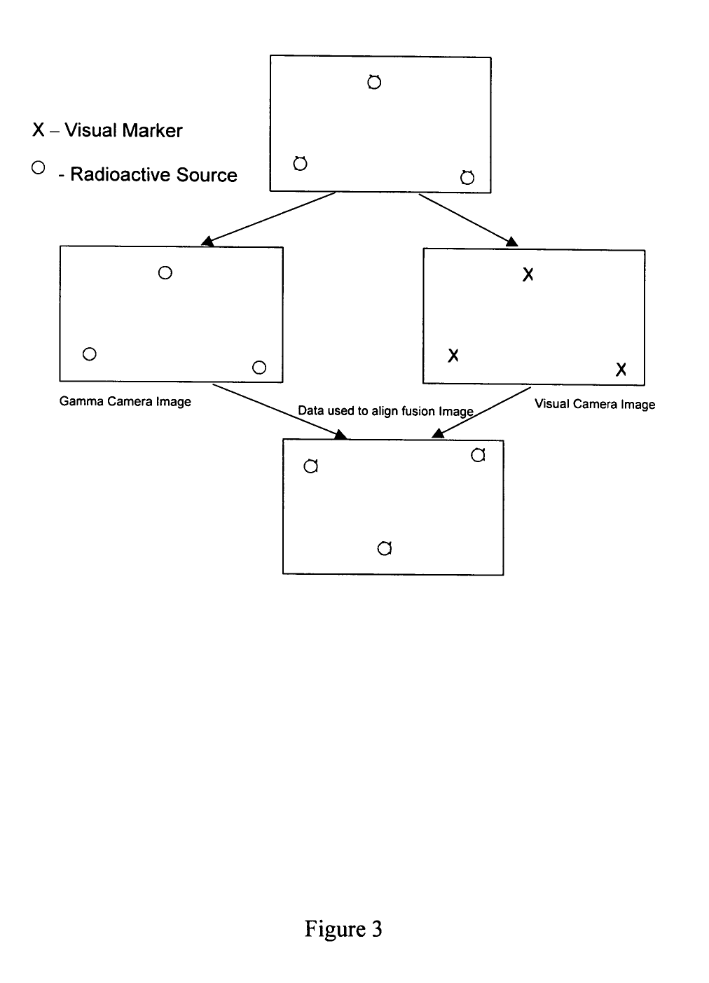

Resolution of the gamma-camera is lower than that of the photographic camera and the data matrix is typically courser. The scintigraphic image will therefore be interpolated to the size of the visual image, scaled, rotated and translated as needed to accurately superimpose the two images. On a frequent basis, imaging of a ‘phantom’ will be performed which physically combines several areas of visual and scintigraphic signal (FIG. 3) and takes advantage of the fixed geometric relationship between the cameras. This will allow the visual and scintigraphic images to be mapped to accurately superimpose the images.

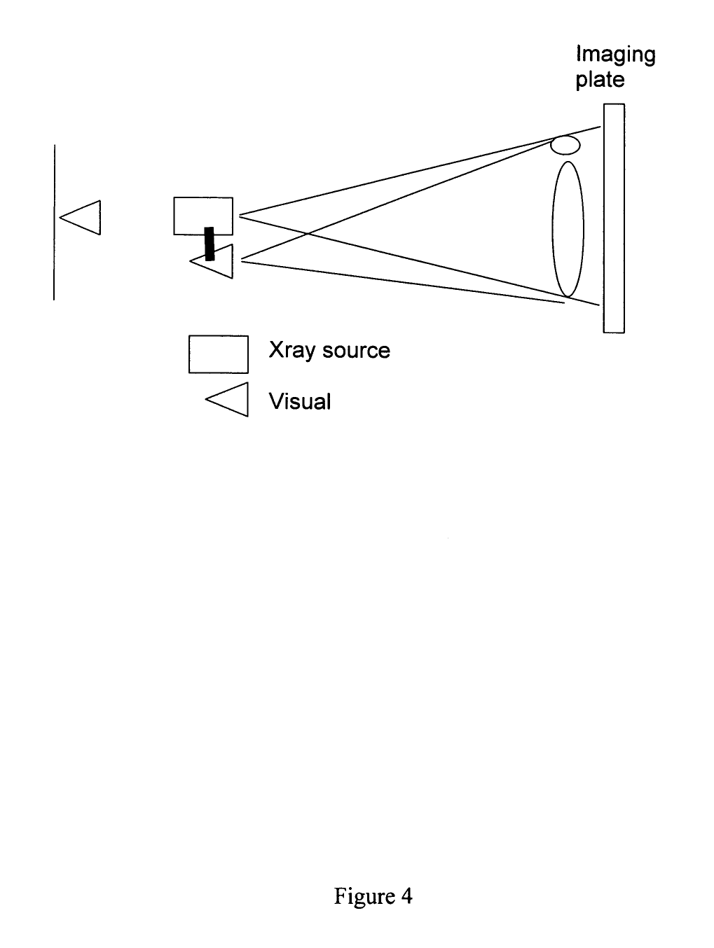

In one embodiment the visual cameras are superimposed with x-ray imaging equipment. In this application, the visual camera could either be attached to the x-ray tube assembly (FIG. 4), or be mounted on a structure in the imaging room (FIG. 4). After acquisition of the x-ray image, a photographic image could be obtained. Based on a fixed relationship between the x-ray machine and the photographic camera, the two images could be scaled and superimposed to generate a ‘fusion’ image. This would be useful in localizing abnormalities on the x-ray image to the patient's skin surface. For instance, the skin overlying an area of bone tumor could be localized to facilitate minimally invasive surgery.

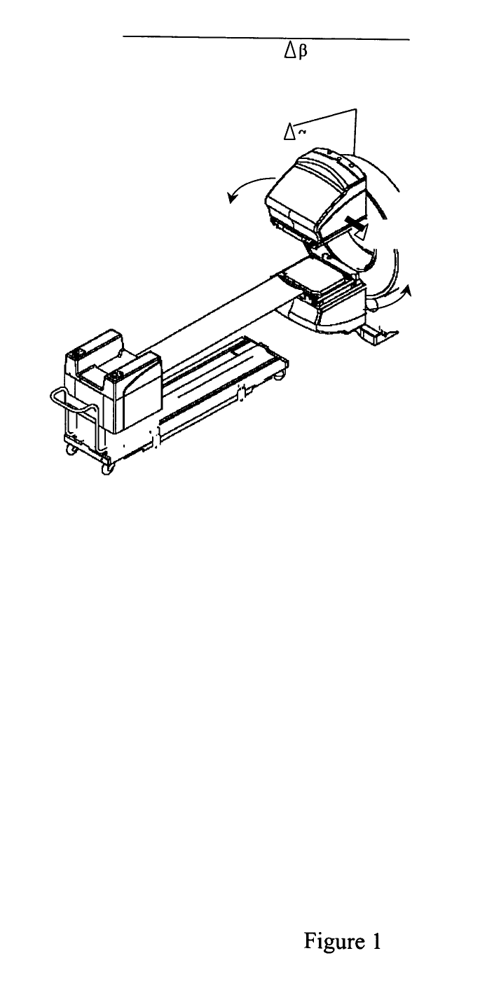

FIG. 1 depicts three possible positions for the visual camera (triangle) when used together with a gamma camera. The visual camera may be attached to the gantry above the scintigraphic head which will subsequently rotate out of the way (α). The visual camera can be attached to the ceiling whereupon the scintigraphic head will rotate out of the way (β). Finally, the visual camera can be mounted on the scintigraphic head (y, see FIG. 2).

FIG. 2 depicts a position in which the gamma camera is located above the patient and acquires the scintigraphic image. The camera then rotates several degrees until the visual camera (triangle) overlies the patient and a visual image is acquired. These two images are then ‘fused’ on a computer.

FIG. 3 depicts a device that generates both a visual and scintigraphic phantom signal at several defined locations. These are used to generate a visual and scintigraphic image which are then analyzed to generate coefficients for use in an affine mapping of the two images together. In this way the device is corrrelated for the fixed positional relationship of the visual and scintigraphic cameras.

FIG. 4 depicts combining x-ray images with visual images in the present invention. The x-ray image is formed from an x-ray tube (rectangle) which produces photons that pass through the patient and expose an imaging plate (either x-ray film or solid state detector). The visual camera (triangle) either can be placed adjacent to the x-ray tube, or in the room at a fixed geometric location relative to the x-ray system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A medical imaging system comprising
an imaging or treatment source and
a visual photographic camera having or movable to a predetermined position with respect to the imaging or treatment source.

2. The medical imaging system of claim 1, wherein the imaging or treatment source is an x-ray imaging source.

3. The medical imaging system of claim 2, wherein the visual camera (is adjacent to the x-ray imaging source.

4. The medical imaging system of claim 2, wherein the visual camera is at a fixed geometric location relative to the x-ray system.

5. The medical imaging system of claim 1, wherein the imaging or treatment source comprises a gamma-camera.

6. The medical imaging system of claim 5, wherein the gamma-camera comprises an Anger camera.

7. The medical imaging system of claim 5 wherein the gamma camera is attached to a gantry and the visual photographic camera is attached to the gantry.

8. The medical imaging system of claim 5 wherein the gamma camera has a head, the visual photographic camera is attached to the gamma-camera head the gamma-camera head can rotate to bring the visual camera over the patient.

9. The medical imaging system of claim 5 wherein the visual photographic camera is attached to a fixed structure.

10. The medical imaging system of claim 5, wherein the gamma-camera comprises a scintigraphic camera.

11. The medical imaging system of claim 5, wherein the gamma-camera comprises an Anger camera.

12. The medical imaging system of claim 1 wherein the imaging or treatment source comprises an x-ray source.

13. The method of imaging a patient using a fusion image combined from the images produced by an imaging or treatment source and a visual photographic camera having or movable to a predetermined position with respect to the imaging or treatment source, wherein a phantom object is imaged by both the imaging or treatment source and the visual photographic camera and the images produced are fused into a single image.

14. The method of imaging a patient using a fusion image combined from the images produced by a gamma camera located above a patient and a visual photographic camera having or movable to a predetermined position with respect to the gamma camera, comprising the steps of
acquiring a scintigraphic image
rotating the gamma camera until the visual camera overlies the patient and a visual image is acquired, and
fusing the two images.
